(19) United States
(12) Patent Application Publication
(10) Pub. No.: US 2010/0010811 A1
(43) Pub. Date: Jan. 14, 2010

(54) STEREO AUDIO ENCODING DEVICE, STEREO AUDIO DECODING DEVICE, AND METHOD THEREOF

(75) Inventors: Jiong Zhou, Singapore (SG); Sua Hong Neo, Singapore (SG); Koji Yoshida, Osaka (JP); Michiyo Goto, Osaka (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/376,025

(22) PCT Filed: Aug. 2, 2007
(86) PCT No.: PCT/JP2007/065133

§ 371 Date: Mar. 25, 2009

(30) Foreign Application Priority Data
Aug. 4, 2006 (JP) 2006-213963

(51) Int. Cl. G10L 19/00

(52) U.S. Cl. 704/219; 704/500; 704/E19.023; 704/E21.001

(57) ABSTRACT

Disclosed is a stereo audio encoding device capable of reducing a bit rate. In this device, a stereo audio encoding unit (103) performs LPC analysis on an L channel signal and an R channel signal so as to obtain an L channel LPC coefficient and an R channel LPC coefficient. An LPC coefficient adaptive filter (105) obtains an LPC coefficient adaptive filter parameter to minimize the mean square error between the L channel LPC coefficient and the R channel LPC coefficient. An LPC coefficient reconfiguration unit (106) reconfigures the R channel LPC coefficient by using the L channel LPC coefficient and the LPC coefficient adaptive filter parameter. A route calculation unit (107) calculates a polynomial route indicating the safety of the R channel reconfigured LPC coefficient. A selection unit (108) selects and outputs the LPC coefficient adaptive filter parameter or the R channel LPC coefficient according to the safety of the R channel reconfigured LPC coefficient.

### TECHNICAL FIELD

The present invention relates to a stereo speech coding apparatus, stereo speech decoding apparatus and methods used in conjunction with these apparatuses, used upon coding and decoding of stereo speech signals in mobile communications systems or in packet communications systems utilizing the Internet protocol (IP).

### BACKGROUND ART

In mobile communications systems and in packet communications systems utilizing IP, advancement in the rate of digital signal processing by DSPs (Digital Signal Processors) and enhancement of bandwidth have been making possible high bit rate transmissions. If the transmission rate continues increasing, bandwidth for transmitting a plurality of channels can be secured (i.e. wideband), so that, even in speech communications where monophonic technologies are popular, communications based on stereophonic technologies (i.e. stereo communications) is anticipated to gain popularity. In wideband stereophonic communications, more natural sound environment-related information can be encoded, which, when played on headphones and speakers, evokes spatial images the listener is able to perceive.

As a stereo speech coding method, there is a non-parametric method of separately coding and transmitting a plurality of channels signals constituting stereo speech signals. For example, LPC (Linear Prediction Coding) coding methods such as the CELP method are used commonly as speech coding methods, and, in CELP coding of a stereo speech signal, the LPC coefficients of the left channel signal and the right channel signal constituting the stereo speech signal are acquired separately, and these LPC coefficients are quantized and transmitted to the decoding apparatus end (see, for example, non-patent document 1).

[Non-Patent Document 1] Guylain Roy and Peter Kabal, “Wideband CELP Speech Coding at 16 kbits/sec” in Proc. ICASSP '91, Toronto, Canada, May, 1991, p. 17-20

### DISCLOSURE OF INVENTION

### Problems To Be Solved By the Invention

However, a plurality of channels constituting a stereo speech signal (e.g. the left and right channel signals) are similar and are different only in the amplitude and time delay. That is to say, cross correlation is high between channels signals and the left channel coding parameters and the right channel coding parameters contain overlapping information, which represents redundancy. For example, if the left and right channel signals that are similar are subjected to CELP coding and the LPC coefficients of both channels are acquired, these LPC coefficients would present a high level of cross correlation and redundancy, thus providing a cause of decrease in the bit rate.

Then, to encode a stereo speech signal, a method of eliminating the redundancy with the coding parameters of a plurality of channels and reducing the bit rate, that is, a parametric coding method is a possibility. In CELP coding, eliminating the redundancy between the left channel LPC coefficients and the right channel LPC coefficients, which arises from the cross-correlation between the left channel and the right channel would make possible further bit rate reduction.

It is therefore an object of the present invention to provide a stereo speech coding apparatus, stereo speech decoding apparatus and stereo speech coding method that make it possible, in CELP coding, to eliminate the redundancy between the left channel LPC coefficients and the right channel LPC coefficients, arising from the cross-correlation between the left channel and the right channel, and reduce the bit rate in the stereo speech coding apparatus.

### Means for Solving the Problem

The stereo speech coding apparatus according to the present invention employs a configuration including: a linear prediction coding analysis section that performs a linear prediction coding analysis of a first channels signal and a second channel signal constituting stereo speech, and acquires a first channel linear prediction coding coefficient and a second channel linear prediction coding coefficient; a linear prediction coding coefficient adaptive filter that finds a linear prediction coding coefficient adaptive filter parameter that minimizes a mean square error between the first channel linear prediction coding coefficient and the second channel linear prediction coding coefficient; and a related information determining section that acquires information related to the second channel linear prediction coding coefficient using the first channel linear prediction coding coefficient, the second channel linear prediction coding coefficient and the linear prediction coding coefficient adaptive filter parameter.

The stereo speech decoding apparatus according to the present invention employs a configuration including: a separation section that separates, from a bit stream that is received, a first channel linear prediction coding coefficient and information related to a second channel linear prediction coding coefficient, generated in a speech coding apparatus using a first channel signal and second channel signal constituting stereo speech; and a linear prediction coding coefficient determining section that checks whether the information related to the second channel linear prediction coding coefficient comprises the linear prediction coding coefficient adaptive filter parameter, filters the first channel liner prediction coding coefficient using the linear prediction coding coefficient adaptive filter parameter when the information related to the second channel linear prediction coding coefficient comprises the linear prediction coding coefficient adaptive filter parameter and outputs a resulting second channel reconstruction linear prediction coding coefficient, and outputs the second channel linear prediction coding coefficient when the information related to the second channel linear prediction coding coefficient comprises the second channel linear prediction coding coefficient.

### Advantageous Effect of the Invention

With the present invention, LPC coefficient adaptive filter parameters to minimize the mean square error between the first channel LPC coefficients and the second channel LPC coefficients are determined and transmitted, so that it is possible to prevent sending information that is redundant between the LPC coefficients of the left channel and the LPC coefficients of the right channel. Consequently, the present invention makes it possible to eliminate the redundancy in encoded information that is transmitted, and reduce the bit rate in stereo speech coding.

### BRIEF DESCRIPTION OF DRAWINGS

FIG. 1 is a block diagram showing primary configurations in a stereo speech coding apparatus according to an embodiment of the present invention;

FIG. 2 is a block diagram showing primary configurations inside a stereo speech coding section according to an embodiment of the present invention;

FIG. 3 explains by way of illustration the configuration and operations of an adaptive filter constituting an LPC coefficient adaptive filter according to an embodiment of the present invention;

FIG. 4 is a flowchart showing an examples of the steps of stereo speech coding processing in a stereo speech coding apparatus according to an embodiment of the present invention;

FIG. 5 is a block diagram showing primary configurations in a stereo speech decoding apparatus according to an embodiment of the present invention;

FIG. 6 is a block diagram showing primary configurations inside a stereo speech decoding section according to an embodiment of the present invention;

FIG. 7 is a flowchart showing an example of the steps of stereo speech coding processing in a stereo speech decoding apparatus according to an embodiment of the present invention;

FIG. 8 shows an example of a stereo speech signal that is received as input in a stereo speech coding apparatus according to an embodiment of the present invention;

FIG. 9 shows LPC coefficients acquired by an LPC analysis of a stereo speech signal according to an embodiment of the present invention; and

FIG. 10 shows a comparison between LPC coefficients that are generated by a direct LPC analysis and reconstructed LPC coefficients that are reconstructed using an adaptive filter, according to an embodiment of the present invention.

### BEST MODE FOR CARRYING OUT THE INVENTION

Now, an embodiment of the present invention will be described below in detail with reference to the accompanying drawings.

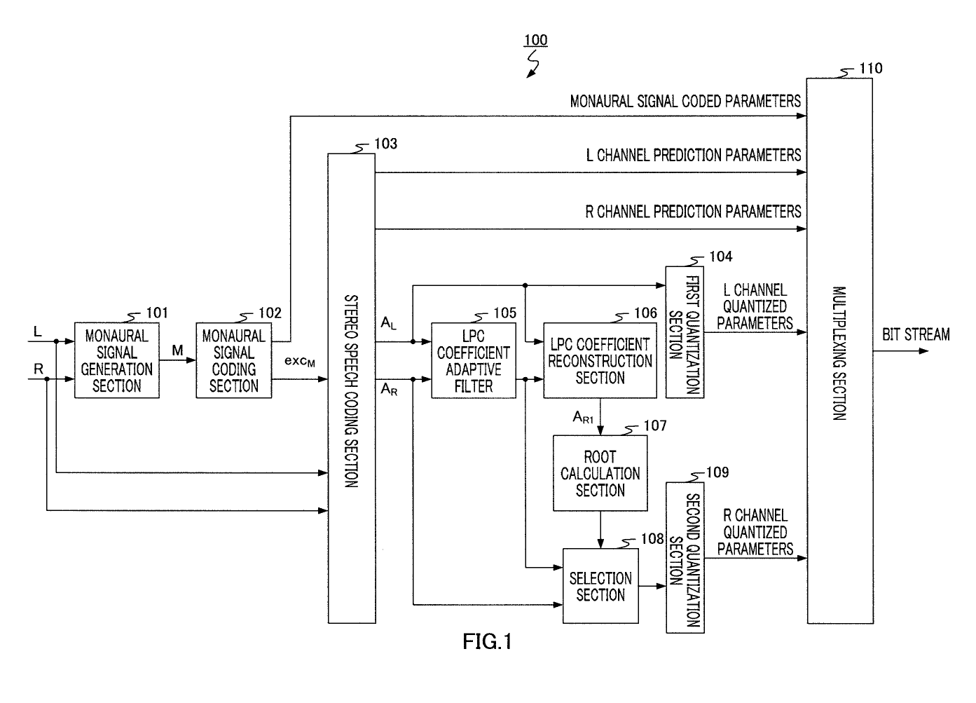

FIG. 1 is a block diagram showing primary configurations in stereo speech coding apparatus 100 according to an embodiment of the present invention. A case will be described here as an example where a stereo speech signal is comprised of the left (“L”) channel signal and the right (“R”) channel signal.

Monaural signal generation section 101 generates a monaural signal (M), according to, for example, equation 1 below, using the L channel signal and R channel signal received as input, and outputs the monaural signal to monaural signal coding section 102.

$$\begin{matrix}[ 1 ] & \\ M ( n ) = \frac{1}{2} [ L ( n ) + R ( n ) ] & ( Equation 1 )\end{matrix}$$

In this equation, n is the sample number of a signal in the time domain, L(n) is the L channel signal, R(n) is the R channel signal and M(n) is the monaural signal generated.

Monaural signal coding section 102 performs speech coding processing such as AMR-WB (Adaptive MultiRate-Wideband) of the monaural signal received as input from monaural signal generation section 101, outputs the resulting monaural signal coded parameters to multiplexing section 110, and outputs the monaural excitation signal (exc_{M}) acquired over the course of coding, to stereo speech coding section 103.

Using the L channel signal, the R channel signal, and the monaural excitation signal (exc_{M}) received as input from monaural signal coding section 102, stereo speech coding section 103 calculates the L channel prediction parameters and the R channel prediction parameters for predicting the L channel and the R channel from the monaural signal, respectively, and outputs these parameters to multiplexing section 110. Then, stereo speech coding section 103 outputs the L channel LPC coefficients (A_{L}), acquired by an LPC analysis of the L channel signal, to LPC coefficient adaptive filter 105 and first quantization section 104. Furthermore, stereo speech coding section 103 outputs the R channel LPC coefficients (A_{R}), acquired by an LPC analysis of the R channel signal, to LPC coefficient adaptive filter 105 and selection section 108. Note that the details of stereo speech coding section 103 will be described later.

First quantization section 104 quantizes the L channel LPC coefficients (A_{L}) received as input from stereo speech coding section 103, and outputs the resulting L channel quantization parameters to multiplexing section 110.

Using the L channel LPC coefficients (A_{L}) and the R channel LPC coefficients (A_{R}) received as input from stereo speech coding section 103 as the input signal and the reference signal, respectively, LPC coefficient adaptive filter 105 finds adaptive filter parameters that minimize the mean square error (MSE) between the input signal and the reference signal. The adaptive filter parameters found in LPC coefficient adaptive filter 105 will be hereinafter referred to as “LPC coefficient adaptive filter parameters.” LPC coefficient adaptive filter 105 outputs the LPC coefficient adaptive filter parameters found, to LPC coefficient reconstruction section 106 and selection section 108. Filter coefficient reconstruction section 106 filters the L channel LPC coefficients (A_{L}) received as input from stereo speech coding section 103 by the LPC coefficient adaptive filter parameters received as input from LPC coefficient adaptive filter 105, and reconstructs the R channel LPC coefficients. LPC coefficient reconstruction section 106 outputs the resulting R channel reconstruction LPC coefficients (A_{R1}) to root calculation section 107.

Using the R channel reconstruction LPC coefficients (A_{R1}) received as input from LPC coefficient reconstruction section 106, root calculation section 107 calculates the greatest root (i.e. root in the z domain) of the polynomial given as equation 2 below, and outputs the result to selection section 108.

$$\begin{matrix}[ 2 ] & \\ 1 - {\sum }_{m = 1}^{p} {A}_{R 1} ( m ) {z}^{- m} & ( Equation 2 )\end{matrix}$$

In this equation, m is an integer (m>0), A_{R1} (m) is the element of A_{R1}, and p is the order of the LPC coefficients.

Based on the values of the roots received as input from root calculation section 107, selection section 108 selects, as information related to the R channel LPC coefficients (A_{R}), one of the R channel LPC coefficients received as input from stereo speech coding section 103 and the LPC coefficient adaptive filter parameters received as input from LPC coefficient adaptive filter 105, and outputs the selection result to second quantization section 109.

To be more specific, if the greatest value of the roots received as input from root calculation section 107 is inside the unit circle, that is, if the greatest absolute value of the roots is equal to or less than 1, selection section 108 decides that the R channel reconstruction LPC coefficients meet the required stability, and outputs the LPC coefficient adaptive filter parameters to second quantization section 109 as the information related to the R channel LPC coefficients. To say that the R channel reconstruction LPC coefficients acquired in LPC coefficient reconstruction section 106 meet the required stability means that, if decoding is performed in the stereo speech decoding end using the LPC coefficient adaptive filter parameters, the resulting decoded stereo speech signal meets the required quality. Generally speaking, the similarity between the L channel signal and the R channel signal constituting a stereo speech signal is high, and, following this, the correlation between the L channel LPC coefficients and the R channel LPC coefficients found in stereo speech coding section 103 is high, and the stability of the R channel reconstruction LPC coefficients acquired in LPC coefficient reconstruction section 106 improves. In this case, selection section 108 selects the LPC coefficient adaptive filter parameters, which contain a smaller amount of information than the R channel LPC coefficients, as the information related to the R channel LPC coefficients. However, there are cases where the greatest value of the roots received as input from root calculation section 107 is outside the unit circle, that is, cases where the greatest absolute value of the roots is greater than 1, such as when the similarity between the L channel signal and the R channel signal constituting a stereo speech signal received as input in stereo speech coding apparatus 100 is low. In such cases, selection section 108 decides that the R channel reconstruction LPC coefficients acquired in LPC coefficient reconstruction section 106 do not meet the required stability, and selects the R channel LPC coefficients (A_{R}) as the information related to the R channel LPC coefficients. When the R channel LPC coefficients are selected in selection section 108, stereo speech coding apparatus 100 transmits the L channel LPC coefficients and R channel LPC coefficients separately.

Second quantization section 109 quantizes the information related to the R channel LPC coefficients received as input from selection section 108, and outputs the resulting R channel quantization parameters to multiplexing section 110.

Multiplexing section 110 multiplexes the monaural signal coded parameters received as input from monaural signal coding section 102, the L channel prediction parameters and R channel prediction parameters received as input from stereo speech coding section 103, the L channel quantization parameters received as input from first quantization section 104 and the R channel quantization parameters received as input from second quantization section 109, and transmits the resulting bit stream.

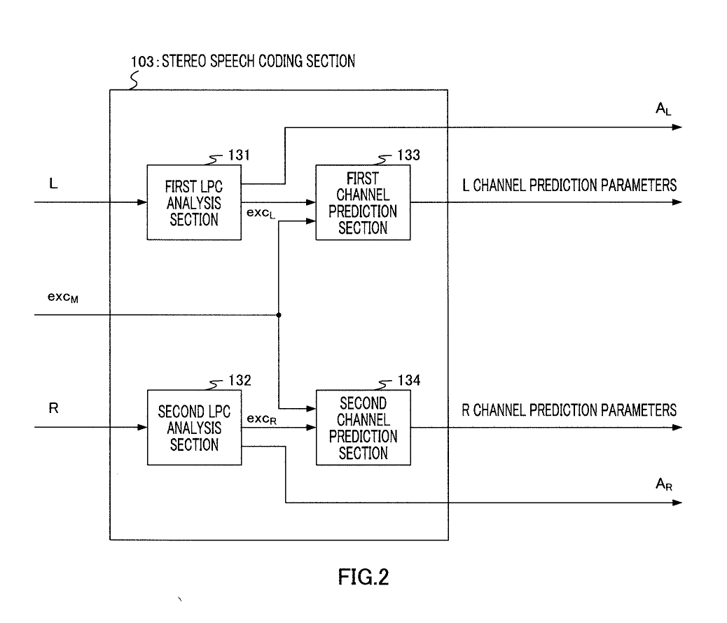

FIG. 2 is a block diagram showing primary configurations inside stereo speech coding section 103.

First LPC analysis section 131 performs an LPC analysis of the L channel signal received as input, and outputs the resulting L channel LPC coefficients (A_{L}) to LPC coefficient adaptive filter 105. Furthermore, first LPC analysis section 131 generates an L channel excitation signal (exc_{L}) using the L channel signal and L channel LPC coefficients, and outputs the L channel excitation signal to first channel prediction section 133.

Second LPC analysis section 132 performs an LPC analysis of the R channel signal received as input, and outputs the resulting R channel LPC coefficients (A_{R}) to LPC coefficient adaptive filter 105. Furthermore, second LPC analysis section 132 generates an R channel excitation signal (exc_{R}) using the R channel signal and R channel LPC coefficients, and outputs the R channel excitation signal to second channel prediction section 134.

First channel prediction section 133 is comprised of an adaptive filter, and, using the monaural excitation signal (exc_{M}) received as input from monaural signal coding section 102 and the L channel excitation signal (exc_{L}) received as input from first channel LPC analysis section 131 as the input signal and the reference signal, respectively, finds adaptive filter parameters that minimize the mean square error between the input signal and the reference signal. First channel prediction section 133 outputs the adaptive filter parameters found, to multiplexing section 110, as L channel prediction parameters for predicting the L channel signal from the monaural signal.

Second channel prediction section 134 is comprised of an adaptive filter, and, using the monaural excitation signal (exc_{M}) received as input from monaural signal coding section 102 and the R channel excitation signal (exc_{R}) received as input from second channel LPC analysis section 132 as the input signal and the reference signal, respectively, finds an adaptive filter parameters that minimizes the mean square error between the input signal and the reference signal. Second channel prediction section 134 outputs the adaptive filter parameters found, to multiplexing section 110, as R channel prediction parameters for predicting the L channel signal from the monaural signal.

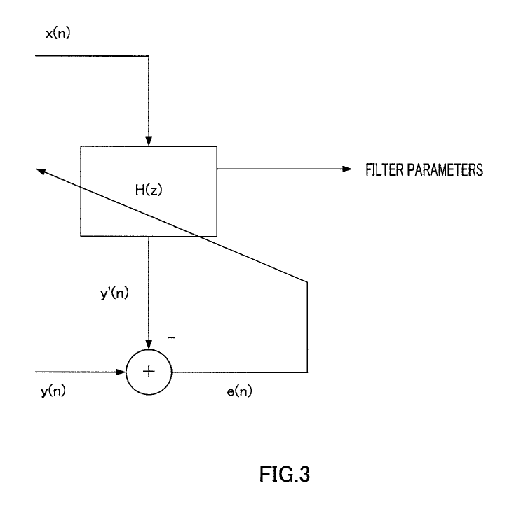

FIG. 3 explains by way of illustration the configuration and operations of the adaptive filter constituting LPC coefficient adaptive filter 105. In this drawing, n is the sample number in the time domain, and H(z) is H(z)=b₀+b₁(z⁻¹)+b₂(z⁻²)+ . . . +bₖ(z^{-k}) and represents an adaptive filter (e.g. FIR (Finite Impulse Response)) model (i.e. transfer function). Here, k is the order of the adaptive filter parameters, and b=[b₀, b₁, . . . , bₖ] is the filter parameters. x(n) is the input signal in the adaptive filter, and, for LPC coefficient adaptive filter 105, the L channel LPC coefficients (A_{L}) received as input from stereo speech coding section 103, are used. Furthermore, y(n) is the reference signal for the adaptive filter, and, with LPC coefficient adaptive filter 105, the R channel LPC coefficients (A_{R}) received as input from stereo speech coding section 103, are used.

The adaptive filter finds and outputs the adaptive filter parameters b=[b₀, b₁, . . . , bₖ] to minimize the mean square error between the input signal and the reference signal, according to equation 3 below.

$$\begin{matrix}[ 3 ] & \\ \begin{matrix}MSE ( n , b ) = E \{ {[ e ( n ) ]}^{2} \} \\ = E \{ {[ y ( n ) - {y}^{′} ( n ) ]}^{2} \} \\ = E \{ {[ y ( n ) - {\sum }_{i = 0}^{k} {b}_{i} x ( n - i ) ]}^{2} \}\end{matrix} & ( Equation 3 )\end{matrix}$$

In this equation, E is the statistical expectation operator, and e(n) is the prediction error.

If the input signal and the reference signal in equation 3 above are substituted using the L channel LPC coefficients (A_{L}) and the R channel LPC coefficients (A_{R}) respectively, the following equation 4 is given.

$$\begin{matrix}[ 4 ] & \\ \begin{matrix}MSE ( m , w ) ≡ E \{ {[ e ( m ) ]}^{2} \} \\ = E \{ {[ {A}_{R} ( m ) - {\sum }_{i = 0}^{q} {w}_{i} {A}_{L} ( m - i ) ]}^{2} \} \end{matrix} & ( Equation 4 )\end{matrix}$$

In this equation, m is the order of the LPC coefficients, wᵢ is the adaptive filter parameters of LPC coefficient adaptive filter 105, and q is the order of the adaptive filter parameters wᵢ.

The configuration and operations of the adaptive filter constituting first channel prediction section 133 are the same as the adaptive filter constituting LPC coefficient adaptive filter 105. Incidentally, the adaptive filter constituting first channel prediction section 133 is different from the adaptive filter constituting LPC coefficient adaptive filter 105 in using the monaural excitation signal (exc_{M}) received as input from monaural signal coding section 102 as the input signal x(n) and using the L channel excitation signal (exc_{L}) received as input from first LPC analysis section 131 as the reference signal y(n).

The configuration and operations of the adaptive filter constituting second channel prediction section 134 are the same as the adaptive filter constituting LPC coefficient adaptive filter 105 or first channel prediction section 133. Incidentally, the adaptive filter constituting first channel prediction section 134 is different from the adaptive filter constituting LPC coefficient adaptive filter 105 or first channel prediction section 133 in using the monaural excitation signal (exc_{M}) received as input from monaural signal coding section 102 as the input signal x(n) and using the R channel excitation signal (exc_{R}) received as input from second LPC analysis section 132 as the reference signal y(n).

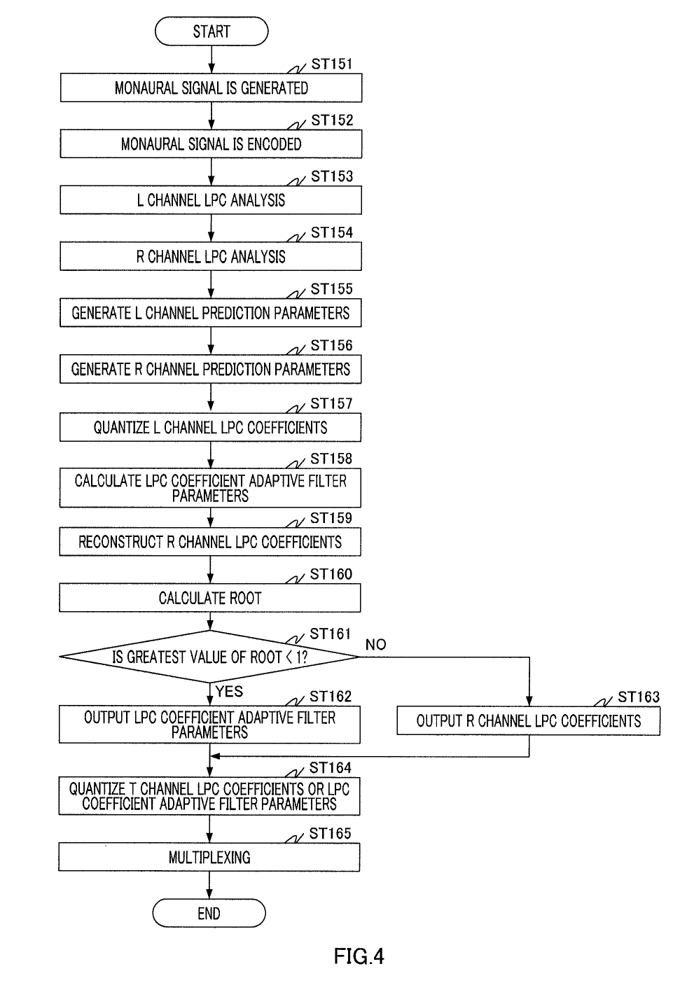

FIG. 4 is a flowchart showing an example of the steps of stereo speech coding processing in stereo speech coding apparatus 100.

First, in step (hereinafter simply “ST”) 151, monaural signal generation section 101 generates a monaural signal (M) using the L channel signal and the R channel signal.

Next, in ST 152, monaural signal coding section 102 encodes the monaural signal (M) and generates monaural signal coded parameters and monaural signal excitation signal (exc_{M}).

Next, in ST 153, first LPC analysis section 131 performs an LPC analysis of the L channel signal and acquires the L channel LPC coefficients (A_{L}) and L channel excitation signal (exc_{L}).

Next, in ST 154, second LPC analysis section 132 performs an LPC analysis of the R channel signal and acquires the R channel LPC coefficients (A_{R}) and R channel excitation signal (exc_{R}).

Next, in ST 155, first channel prediction section 133 finds L channel prediction parameters that minimize the mean square error between the L channel excitation signal (exc_{L}) and the monaural excitation signal (exc_{M})

Next, in ST 156, second channel prediction section 134 finds R channel prediction parameters that minimize the mean square error between the R channel excitation signal (exc_{R}) and the monaural excitation signal (exc_{M}).

Next, in ST 157, first quantization section 104 quantizes the L channel LPC coefficients (A_{L}) and acquires the L channel quantization parameters.

Next, in ST 158, LPC coefficient adaptive filter 105 finds LPC coefficient adaptive filter parameters that minimize the mean square error between the L channel LPC coefficients (A_{L}) and the R channel LPC coefficients (A_{R}).

Next, in ST 159, using the L channel LPC coefficients (A_{L}) and the LPC coefficient adaptive filter parameters, LPC coefficient reconstruction section 106 reconstructs the R channel LPC coefficients and generates the R channel reconstruction LPC coefficients (A_{R1}).

Next, in ST 160, root calculating section 107 calculates the roots for use in the selection process in selection section 108 using the R channel reconstruction LPC coefficients (A_{R1}).

Next, in ST 161, selection section 108 checks whether or not the greatest value of the roots received as input from root calculating section 107 is inside the unit circle, that is, whether or not the absolute value of the greatest root is less than 1.

If the absolute value of the greatest root is decided to be less than 1 (“YES” in ST 161), selection section 108 outputs the LPC coefficient adaptive filter parameters to second quantization section 109 in ST 162. On the other hand, if the absolute value of the greatest root is decided to be equal to or greater than 1 (“NO” in ST 161), selection section 108 outputs the R channel LPC coefficients (A_{R}) to second quantization section 109 in ST 163.

Next, in ST 164, second quantization section 109 quantizes the R channel LPC coefficients (A_{R}) or the LPC coefficient adaptive filter parameters, and acquires the R channel quantization parameters.

Next, in ST 165, multiplexing section 110 multiplexes the monaural signal coded parameters, L channel signal parameters, R channel prediction parameters, L channel quantization parameters and R channel quantization parameters, and transmits the resulting bit stream.

As described above, when the LPC coefficient adaptive filter parameters, which is the prediction parameters between the L channel LPC coefficients and the R channel LPC coefficients, meets the condition for decision according to equation 2, stereo speech coding apparatus 100 transmits the LPC coefficient adaptive filter parameters, which contain a smaller amount of information than the R channel LPC coefficients, to stereo speech decoding apparatus 200.

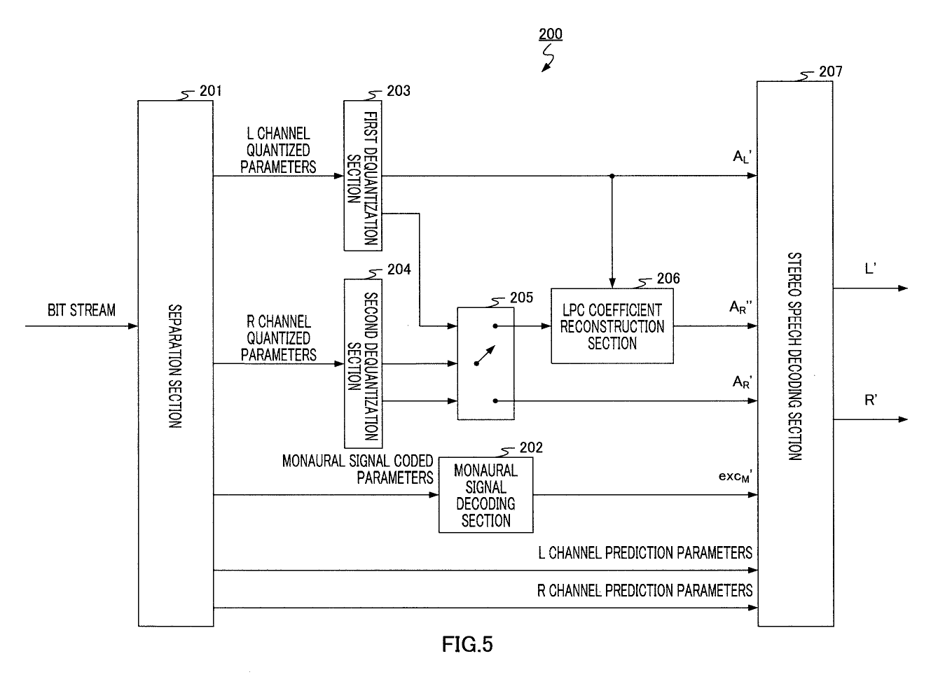

FIG. 5 is a block diagram showing primary configurations in stereo speech decoding apparatus 200.

Separation section 201 performs a separating process of the bit stream transmitted from stereo speech coding apparatus 100, outputs the resulting monaural signal coded parameters to monaural signal decoding section 202, outputs the L channel prediction parameters and R channel prediction parameters to stereo speech decoding section 207, outputs the L channel quantization parameters to first dequantization section 203 and outputs the R channel quantization parameters to second dequantization section 204.

Monaural signal decoding section 202 performs speech decoding processing such as AMR-WB using the monaural signal coded parameters received as input from separation section 201, and outputs the monaural excitation signal generated (exc_{M}′), to stereo speech decoding section 207.

First dequantization section 203 performs a dequantization process of the L channel quantization parameters received as input from separation section 201, and outputs the resulting L channel LPC coefficients to LPC coefficient reconstruction section 206 and stereo speech decoding section 207. Furthermore, first dequantization section 203 determines the length of the L channel LPC coefficients and outputs this to switching section 205.

Second dequantization section 204 dequantizes the R channel quantization parameters received as input from separation section 201, and outputs the resulting information related to the R channel LPC coefficients, to switching section 205. Furthermore, second dequantization section 204 determines the length of the information related to the R channel LPC coefficients and outputs this to switching section 205.

Switching section 205 compares the length of the information related to the R channel LPC coefficients received as input from second dequantization section 204 and the length of the L channel LPC coefficients received as input from first dequantization section 203, and, based on the comparison result, switches the output destination of the information related to the R channel LPC coefficients received as input from second dequantization section 204 between LPC coefficient reconstruction section 206 and stereo speech decoding section 207. To be more specific, if the length of the information related to the R channel LPC coefficients received as input from second dequantization section 204 and the length of the L channel LPC coefficients received as input from first dequantization section 203 are equal, it is decided that the information related to the R channel LPC coefficients received as input from second dequantization section 204 is the R channel LPC coefficients, and the R channel LPC coefficients are outputted to stereo speech decoding section 207. On the other hand, if the length of the information related to the R channel LPC coefficients received as input from second dequantization section 204 and the length of the L channel LPC coefficients received as input from first dequantization section 203 are different, it is decided that the information related to the R channel LPC coefficients received as input from second dequantization section 204 is the LPC coefficient adaptive filter parameters and the LPC coefficient adaptive filter parameters are outputted to LPC coefficient reconstruction section 206.

LPC coefficient reconstruction section 206 reconstructs the R channel LPC coefficients using the L channel LPC coefficients received as input from first dequantization section 203 and the LPC coefficient adaptive filter parameters received as input from switching section 205, and outputs the resulting R channel reconstruction LPC coefficients (A_{R}″) to stereo speech decoding section 207.

Stereo speech decoding section 207 reconstructs the L channel signal and R channel signal using the L channel prediction parameters and R channel prediction parameters received as input from separation section 201, the monaural excitation signal (exc_{M}′) received as input from monaural signal decoding section 202, the L channel LPC coefficients (A_{L}′) received as input from first dequantization section 203, the R channel LPC coefficients (A_{R}′) received as input from switching section 205, and the R channel reconstruction LPC coefficients (A_{R}″) received as input from LPC coefficient reconstruction section 206, and outputs the resulting L channel signal (L′) and R channel signal (R′) as a decoded stereo speech signal. Then, if stereo speech decoding section 207 receives as input the R channel LPC coefficients (A_{R}′) from switching section 205, the R channel reconstruction LPC coefficients (A_{R}″) from LPC coefficient reconstruction section 206 is not inputted. Instead, if the stereo speech decoding section 207 receives as input the R channel reconstruction LPC coefficients (A_{R}″) from LPC coefficient reconstruction section 206, the R channel LPC coefficients (A_{R}′) from switching section 205 are not received as input. That is to say, stereo speech decoding section 207 selects and uses one of the R channel LPC coefficients (A_{R}′) received as input from switching section 205 and the R channel reconstruction LPC coefficients (A_{R}″) received as input from LPC coefficient reconstruction section 206, and reconstructs the L channel signal and the R channel signal.

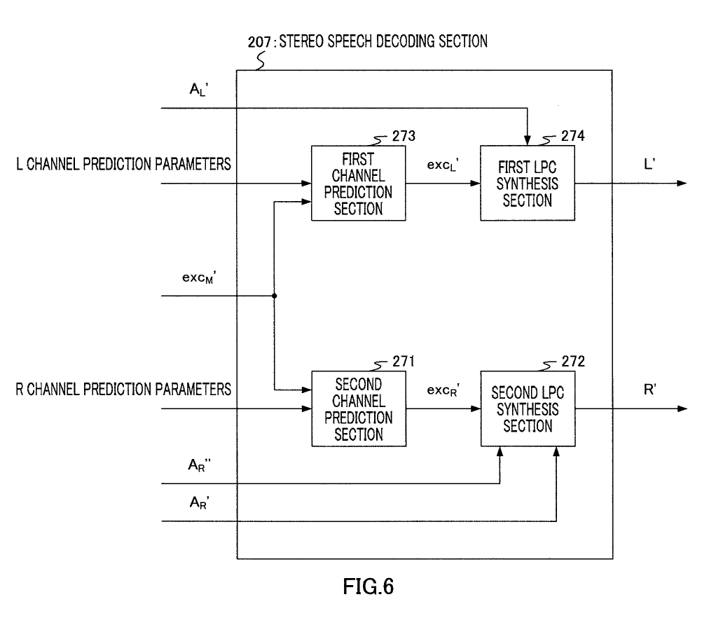

FIG. 6 is a block diagram showing primary configurations inside stereo speech decoding section 207.

As the method of predicting the R channel excitation signal, second channel prediction section 271 filters the monaural excitation signal (exc_{M}′) received as input from monaural signal decoding section 202, by the R channel prediction parameters received as input from separation section 201, and outputs the resulting R channel excitation signal (exc_{R}′) to second LPC synthesis section 272.

Second LPC synthesis section 272 performs an LPC synthesis using the R channel LPC coefficients (A_{R}′) received as input from switching section 205, the R channel reconstruction LPC coefficients (A_{R}″) received as input from LPC coefficient reconstruction section 206 and the R channel excitation signal (exc_{R}′) received as input from second channel prediction section 271, and outputs the resulting R channel signal (R′) as a decoded stereo speech signal. Then, second channel LPC synthesis section 272 selects and uses one of the R channel LPC coefficients (A_{R}′) received as input from switching section 205 and the R channel reconstruction LPC coefficients (A_{R}″) received as input from LPC coefficient reconstruction section 206. Then, if second LPC synthesis section 272 receives as input the R channel LPC coefficients (A_{R}′) from switching section 205, the R channel reconstruction LPC coefficients (A_{R}″) from LPC coefficient reconstruction section 206 is not inputted. Instead, if second LPC synthesis section 272 receives as input the R channel reconstruction LPC coefficients (A_{R}″) from LPC coefficient reconstruction section 206, the R channel LPC coefficients (A_{R}′) from switching section 205 are not received as input.

First channel prediction section 273 predicts the L channel excitation signal using the L channel prediction parameters received as input from separation section 201 and the monaural excitation signal (exc_{M}′) received as input from monaural signal decoding section 202, and outputs the L channel excitation signal generated (exc_{L}′) to first LPC synthesis section 274.

First LPC synthesis section 274 performs an LPC synthesis using the L channel LPC coefficients (A_{L}′) received as input from first dequantization section 203 and the L channel excitation signal (exc_{L}′) received as input from first channel prediction section 273, and outputs the L channel signal generated (L′) as a decoded stereo speech signal.

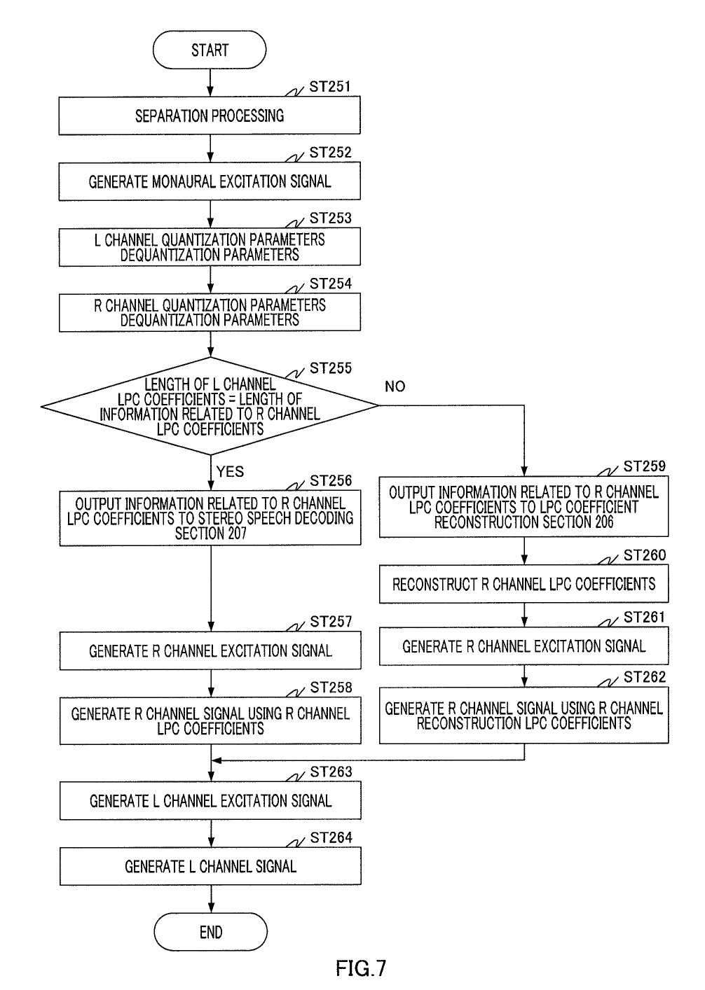

FIG. 7 is a flowchart showing the steps of stereo speech coding processing in stereo speech decoding apparatus 200.

First, in ST 251, separation section 201 performs separation processing using a bit stream received as input from stereo speech coding apparatus 100, and acquires the monaural signal coded parameters, L channel prediction parameters, R channel prediction parameters, L channel quantization parameters and R channel quantization parameters.

Next, in ST 252, monaural signal decoding section 202 performs speech decoding processing such as AMR-WB using the monaural signal coded parameters, and acquires a monaural excitation signal (exc_{M}′).

Next, in ST 253, first dequantization section 203 dequantizes the L channel quantization parameters, acquires the resulting L channel LPC coefficients, and, furthermore, determines the length of the L channel LPC coefficients.

Next, in ST 254, second dequantization section 204 dequantizes the R channel quantization parameters, acquires the resulting information related to the R channel LPC coefficients, and, furthermore, determines the length of the information related to the R channel LPC coefficients.

Next, in ST 255, switching section 205 checks whether or not the length of the L channel LPC coefficients and the length of the information related to the R channel LPC coefficients are equal.

If the length of the L channel LPC coefficients and the length of the information related to the R channel LPC coefficients are equal (“YES” in ST 255) switching section 295 decides that the information related to the R channel LPC coefficients is the R channel LPC coefficients, and outputs the information related to the R channel LPC coefficients to second LPC synthesis section 272 inside stereo speech decoding section 207 in ST 256.

Next, in ST 257, second channel prediction section 271 filters the monaural excitation signal (exc_{M}′) by the R channel prediction parameters, and acquires the R channel excitation signal (exc_{R}′).

Next, in ST 258, second LPC synthesis section 272 performs a LPC synthesis using the R channel excitation signal (exc_{R}′) and the R channel LPC coefficients, and outputs the resulting R channel signal (R′) as a decoded stereo speech signal. Next, the process floe moves onto ST 263.

If, on the other hand, the length of the L channel LPC coefficients and the length of the information related to the R channel LPC coefficients are decided to be different (“NO” in ST 255), switching section 205 decides that the information related to the R channel LPC coefficients is the LPC coefficient adaptive filter parameters, and, in ST 259, outputs the information related to the R channel LPC coefficients to LPC coefficient reconstruction section 206.

Next, in ST 260, LPC coefficient reconstruction section 206 filters the L channel LPC coefficients by the LPC coefficient adaptive filtering parameters, and acquires the R channel reconstruction LPC coefficients (A_{R}″).

Next, in ST 261, second channel prediction section 271 filters the monaural excitation signal (exc_{M}′) by the R channel prediction parameters, and acquires the R channel excitation signal (exc_{R}′).

Next, in ST 262, second LPC synthesis section 272 performs an LPC synthesis using the R channel excitation signal (exc_{R}′) and the R channel reconstruction LPC coefficients (A_{R}″), and output the resulting R channel signal (R′) as a decoded stereo speech signal.

Next, in ST 263, first channel prediction section 273 filters the monaural excitation signal (exc_{M}′) by the L channel prediction parameters, and acquires the L channel excitation signal (exc_{L}′).

Next, in ST 264, first LPC synthesis section 274 performs an LPC synthesis using the L channel excitation signal (exc_{L}′) and the L channel LPC coefficients (A_{L}′), and outputs the resulting L channel signal (L′) as a decoded stereo speech signal.

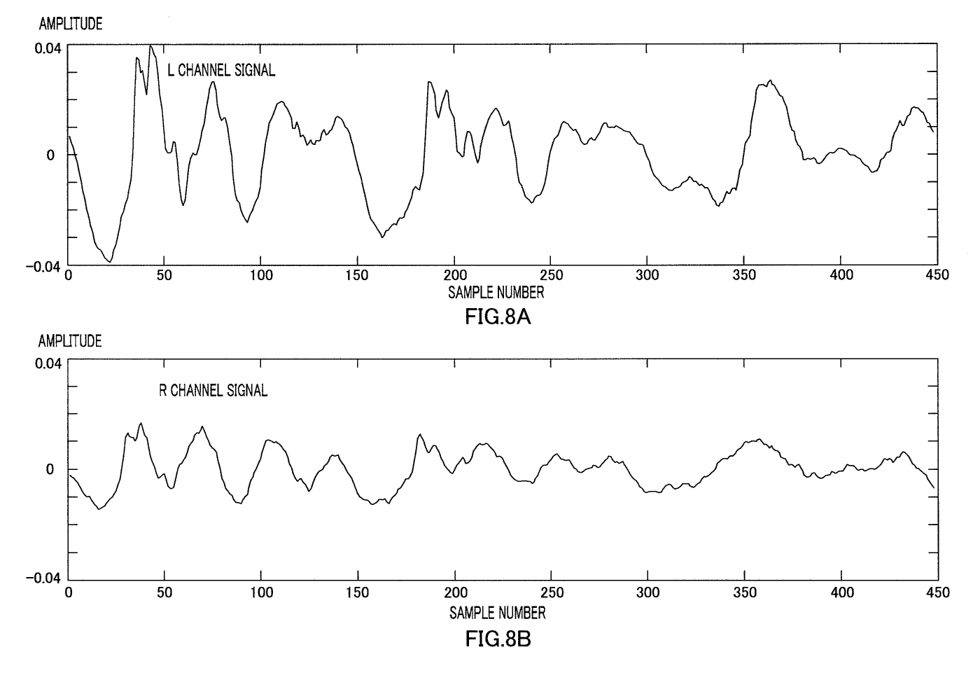

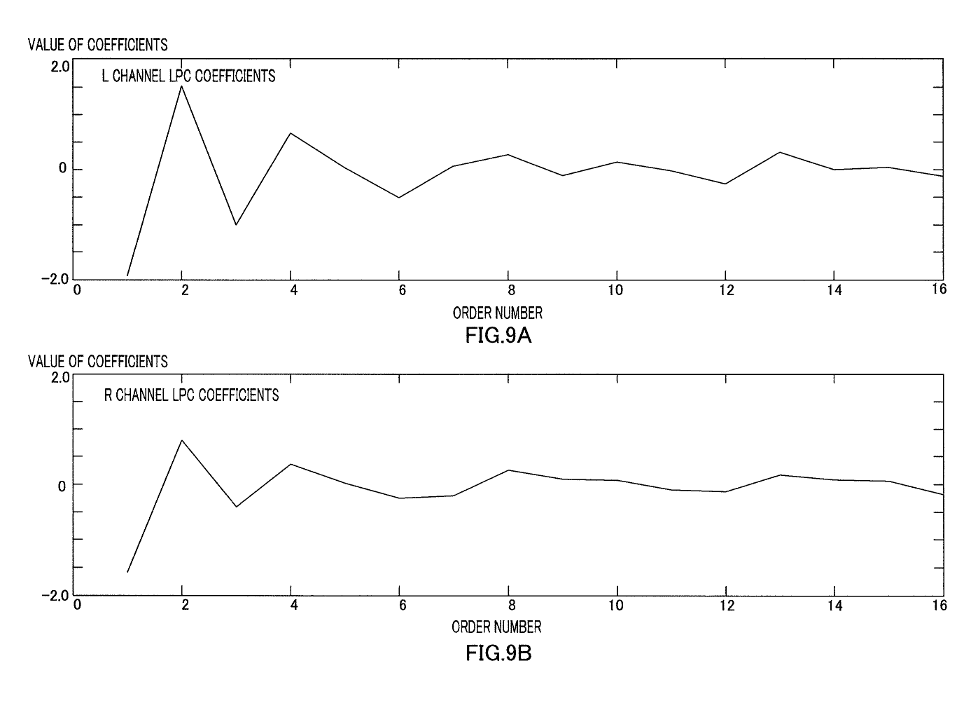

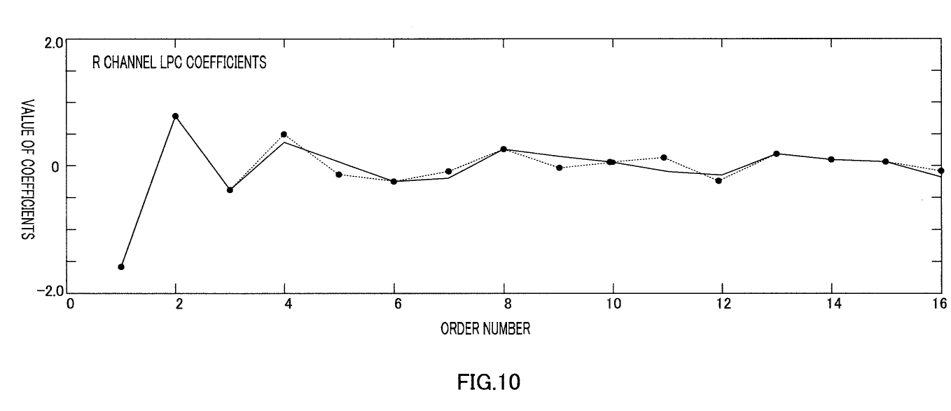

FIG. 8, FIG. 9 and FIG. 10 illustrate an effect of bit rate reduction by the stereo speech coding method according to the present embodiment.

FIG. 8 shows an example of a stereo speech signal received as input in stereo speech coding apparatus 100. In FIG. 8, the horizontal axis is the sample numbers of a stereo speech signal and the vertical axis is the amplitude of the stereo speech signal. FIG. 8A and FIG. 8B shows the L channel signal and the R channel signal constituting a stereo speech signal, respectively. As shown in FIG. 8, the amplitude of the L channel signal and the amplitude of the R channel signal are different, but the waveform of the L channel signal and the waveform of the R channel signal show similarity.

FIG. 9 shows LPC coefficients acquired by an LPC analysis of the stereo speech signal shown in FIG. 8. In FIG. 9, the horizontal axis is the number of the order of LPC coefficients and the vertical axis is the value of each order of the LPC coefficients. FIG. 9 illustrates an example of order 16. FIG. 9A illustrates L channel LPC coefficients (A_{L}) generated in LPC analysis section 131, and FIG. 9B shows R channel LPC coefficients (A_{R}) generated in second LPC analysis section 132. As shown in FIG. 9, the values of L channel LPC coefficients (A_{L}) and the values of R channel LPC coefficients (A_{R}) are different, but the L channel LPC coefficients (A_{L}) and the R channel LPC coefficients (A_{R}) show similarity on the whole.

FIG. 10 shows a comparison between R channel LPC coefficients generated by performing a direct LPC analysis and R channel reconstruction LPC coefficients reconstructed by using an adaptive filter. To be more specific, the solid line shows the R channel LPC coefficients (A_{R}) generated in second LPC analysis section 132, and the dotted line shows the R channel reconstruction LPC coefficients (A_{R1}) reconstructed in LPC coefficient reconstruction section 106. As shown in FIG. 10, if the stereo speech coding method according to the present invention is sued, reconstructed LPC coefficients and LPC coefficients acquired by a direct LPC analysis, are very similar. That is to say, the stability of R channel reconstruction LPC coefficients acquired in LPC coefficient reconstruction section 106 is high, and therefore LPC coefficient adaptive filter parameters are much more likely to be selected in selection section 108 than R channel LPC coefficients, so that it is possible to reduce the bit rate of stereo speech coding apparatus 100.

In FIG. 10, both the adaptive filter constituting the first LPC analysis section according to the present embodiment and the adaptive filter constituting the second LPC analysis section are both have an order of 16, and the adaptive filter constituting LPC adaptive filter 105 have an order of 8. In such cases, it requires 32 bits to transmit directly the L channel LPC coefficients and the R channel LPC coefficients, yet, by contrast, it requires only 24 bits to transmit the L channel LPC coefficients and LPC coefficient adaptive filter parameters, so that it is possible to require the bit rate by 25% and still maintain the quality of coding processing.

Thus, according to the present embodiment, the stereo speech coding apparatus uses the cross-correlation between the L channel signal and the R channel signal, and finds and transmits LPC coefficient adaptive filter parameters, which contain a smaller amount of information than the R channel LPC coefficients, to the stereo speech decoding apparatus. That is to say, the present invention is directed to preventing transmitting information that overlaps between LP channel LPC coefficients and R channel LPC coefficients, so that it is possible to eliminate the redundancy of coding information that is transmitted and reduce the bit rate in the strep speech coding apparatus.

Furthermore, according to the present embodiment, R channel LPC coefficients are reconstructed using LPC coefficient adaptive filter parameters, the stability of the resulting R channel LPC coefficients is determined, and, if the stability of the R channel reconstruction LPC coefficients is equal to or lower than a required level, the LPC coefficients for both channels are transmitted separately, so that the quality of the decoded stereo speech signal can be improved.

Referring to FIG. 5, although with the present embodiment the monaural signal (M′) acquired by the decoding process in monaural signal decoding section 202 is not outputted outside stereo speech decoding apparatus 200, if, for example, the generation of a decoded L channel signal (L′) or decoded R channel signal (R′) fails, it is possible to output the monaural signal (M′) to outside stereo speech decoding apparatus 200 and use it as a decoded speech signal from stereo speech decoding apparatus 200.

The series of processings for the L channel signal and the series of processings for the R channel signal according to the present invention may be reversed. In that case, for example, although with the present embodiment L channel LPC coefficients are used as the input signal in L channel LPC coefficient adaptive filter 105 and R channel LPC coefficients are used as the reference signal in LPC coefficient adaptive filter 105, the R channel LPC coefficients would be used as the input signal in LPC coefficient adaptive filter 193 and the L channel LPC coefficients are used as the reference signal in the LPC coefficient adaptive filter 105.

Furthermore, although a case has been described above with the present embodiment where LPC coefficients are determined and quantized, it is equally possible to determine and quantize other parameters equivalent to LPC coefficients (e.g. LSP parameters).

Furthermore, although an example has been shown above with the present embodiment where the processings in the individual steps are executed in a serial fashion except for the branching “YES” and “NO” decisions in FIG. 4 and FIG. 7, there are steps that can be re-ordered or parallelized. For example, ST 153 and ST 154 maybe placed in an opposite order, or the processing in ST 153 and the processing in ST 154 may be carried out in parallel. The same applies to the reordering/parallelization of ST 155 and ST 156, and the reordering/parallelization of ST 252, ST 253 and ST 254. Furthermore, the processing in ST 157 may be carried out after ST 158 through ST 164 or may be carried out in parallel. The same applies to the processings in ST 255 through ST 262 and the processings in ST 263 through ST 264.

Furthermore, the stereo speech coding apparatus and stereo speech decoding apparatus according to the present invention can be mounted in communications terminal apparatus in mobile communications systems, so that it is possible to provide communications terminal apparatuses that provide the same working effects as described above.

Also, although a case has been described with the above embodiment as an example where the present invention is implemented by hardware, the present invention can also be realized by software as well. For example, the same functions as with the stereo speech coding apparatus according to the present invention can be realized by writing the algorithm of the stereo speech coding method according to the present invention in a programming language, storing this program in a memory and executing this program by an information processing means.

Each function block employed in the description of each of the aforementioned embodiments may typically be implemented as an LSI constituted by an integrated circuit. These may be individual chips or partially or totally contained on a single chip.

“LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of a programmable FPGA (Field Programmable Gate Array) or a reconfigurable processor where connections and settings of circuit cells within an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2006-213963, filed on Aug. 4, 2006, including the specification, drawings and abstract, is incorporated herein by reference in its entirety.

### INDUSTRIAL APPLICABILITY

The stereo speech coding apparatus, stereo speech decoding apparatus and stereo speech coding method according to the present invention are applicable for use in stereo speech coding and so on in mobile communications terminals.

1. A stereo speech coding apparatus comprising:
a linear prediction coding analysis section that performs a linear prediction coding analysis of a first channels signal and a second channel signal constituting stereo speech, and acquires a first channel linear prediction coding coefficient and a second channel linear prediction coding coefficient;
a linear prediction coding coefficient adaptive filter that finds a linear prediction coding coefficient adaptive filter parameter that minimizes a mean square error between the first channel linear prediction coding coefficient and the second channel linear prediction coding coefficient; and
a related information determining section that acquires information related to the second channel linear prediction coding coefficient using the first channel linear prediction coding coefficient, the second channel linear prediction coding coefficient and the linear prediction coding coefficient adaptive filter parameter.

2. The stereo speech coding apparatus according to claim 1, wherein the related information determining section comprises:
a linear prediction coding coefficient reconstruction section that acquires the second channel reconstruction linear prediction coding coefficients by filtering the first channel linear prediction coding coefficient by the linear prediction coding coefficient adaptive filter parameter; and
a selection section that calculates a value representing stability of the second channel reconstruction linear prediction coding coefficient, and, using the value representing the stability of the second channel reconstruction linear prediction coding coefficient, selects between making the linear prediction coding coefficient adaptive filter parameter the information related to the second channel linear prediction coding coefficient and making the second channel linear prediction coding coefficient the information related to the second channel linear prediction coding coefficient.

3. The stereo speech coding apparatus according to claim 1, wherein:
the selection section, using the second channel reconstruction linear prediction coding coefficient, calculates roots of a polynomial in a z domain, as values representing the stability of the second channel reconstruction linear prediction coding coefficient, according to an equation
$$1 - {\sum }_{m = 1}^{p} {A}_{R 1} ( m ) {z}^{- m}$$
where
A_{R1} is the second channel reconstruction linear prediction coding coefficient;
A_{R1} (m) is an element of the second channel reconstruction linear prediction coding coefficients A_{R1}; and
p is an order of the linear prediction coding coefficient adaptive filter; and
the selection section selects the linear prediction coding coefficient adaptive filter parameter as the information related to the second channel linear prediction coding coefficient when a greatest absolute value of the roots is equal to or less than 1 and selects the second channel linear prediction coding coefficient as the information related to the second channel linear prediction coding coefficient when the greatest absolute value of the roots is greater than 1.

4. A stereo speech decoding apparatus comprising:
a separation section that separates, from a bit stream that is received, a first channel linear prediction coding coefficient and information related to a second channel linear prediction coding coefficient, generated in a speech coding apparatus using a first channel signal and second channel signal constituting stereo speech; and
a linear prediction coding coefficient determining section that checks whether the information related to the second channel linear prediction coding coefficient comprises the linear prediction coding coefficient adaptive filter parameter, filters the first channel liner prediction coding coefficient using the linear prediction coding coefficient adaptive filter parameter when the information related to the second channel linear prediction coding coefficient comprises the linear prediction coding coefficient adaptive filter parameter and outputs a resulting second channel reconstruction linear prediction coding coefficient, and outputs the second channel linear prediction coding coefficient when the information related to the second channel linear prediction coding coefficient comprises the second channel linear prediction coding coefficient.

5. A stereo speech coding method comprising the steps of:
performing a linear prediction coding analysis of a first channels signal and a second channel signal constituting stereo speech, and acquiring a first channel linear prediction coding coefficient and a second channel linear prediction coding coefficient;
finding a linear prediction coding coefficient adaptive filter parameter that minimizes a mean square error between the first channel linear prediction coding coefficient and the second channel linear prediction coding coefficient; and
acquiring information related to the second channel linear prediction coding coefficient using the first channel linear prediction coding coefficients, the second channel linear prediction coding coefficient and the linear prediction coding coefficient adaptive filter parameter.
